(19) United States
(12) Patent Application Publication
(10) Pub. No.: US 2005/0014006 A1
(43) Pub. Date: Jan. 20, 2005

(54) Adhesiveless flexible substrate and method of manufacturing the same

(75) Inventor: Yung-Sen Lin, Taiwan City (TW)

Correspondence Address: BACON & THOMAS, PLLC, 625 SLATERS LANE, FOURTH FLOOR, ALEXANDRIA, VA, 22314, US

(73) Assignee: Feng-Chia University, Taiwan City (TW)

(21) Appl. No.: 10/831,177

(22) Filed: Apr. 26, 2004

(30) Foreign Application Priority Data
Jul. 16, 2003 (TW) 92119463

(51) Int. Cl. B32B 15/20; C08J 7/18; B32B 27/30; B32B 27/36; B32B 27/38

(52) U.S. Cl. 428/413; 428/457; 428/473.5; 428/480; 428/522; 427/488; 427/491; 427/404

(57) ABSTRACT

A method of manufacturing an adhesiveless flexible substrate modifies a surface of an electrically insulative flexible base material by plasma polymerization technology to form a layer of plasma polymer on a surface of the electrically insulative flexible base material before plating a copper layer on the base material so as to improve the bond strength of the copper layer and the base material. Because the layer of plasma polymer has a thin thickness and excellent mechanical properties, the adhesiveless flexible substrate is highly flexible.

### BACKGROUND OF THE INVENTION

1. Field of the Invention

The present invention relates to a method of preparing adhesiveless flexible substrate for use to manufacture an adhesiveless copper clad laminate which is of high reliability and flexibility for application to drive IC packaging technology of a COF (Chip on Film) planar display. The invention can also be employed to a process of manufacturing an FPC (Flexible Printed Circuit board).

2. Description of the Related Art

A regular flexible substrate is three-layer structure comprised of an electrically insulative flexible base material, a bonding layer made of polymeric or metallic material such as nickel or chrome, and a copper layer. For the advantages of being light, thin, short, small, and flexible, this design of the flexible substrate is intensively used in communication and electronic consumer products, computer peripheral apparatuses, and liquid crystal displays. However, the bonding layer has a coefficient of heat expansion different from the electrically insulative flexible base material and the copper layer, such that the thermostability of the flexible substrate is poor. Further, the bonding layer lowers the flexibility though the bonding strength between the electrically insulative flexible base material and the copper layer is enhanced. Therefore, this structure of flexible substrate is not practical for the application to the packaging technology that requires high packaging density and high flexibility. In order to eliminate this problem, an adhesiveless flexible substrate without the bonding layer is developed. The adhesiveless flexible substrate has a low weight and a small size, providing better circuit resolution, thermostability, and flexibility, and being highly reliable for a long use.

Recently, manufacturers keep developing COF technology, which enables the drive ICs and other electronic components to be directly put on a film to meet the requirements of being light, thin, short, and small. This technology will soon become the major role in planar display drive IC packaging. However, as the packaging density is enhanced, the pin pitch in connection with this packaging technology must be shortened, and the requirement for improving the reliability and flexibility of flexible substrates has to be heightened. Therefore, it is desirable to provide a flexible substrate that meets those requirements.

### SUMMARY OF THE INVENTION

The present invention has been accomplished under the circumstances in view. It is the primary object of the present invention to provide an adhesiveless flexible substrate and a method of manufacturing the same, which has high bond strength to be reliable for long time of use without reducing the flexibility.

To achieve the foregoing objects of the present invention, the method of manufacturing the adhesiveless flexible substrate comprises the steps of (a) preparing an electrically insulative base material, (b) plating a layer of plasma polymer on a surface of the electrically insulative base material by way of a plasma polymerization process under the presence of a polymerization gas and the application of an electric power, and (c) plating a copper layer on a surface of the layer of plasma polymer.

The adhesiveless flexible substrate comprises the electrically insulative flexible base material, the copper layer, and the layer of plasma polymer sandwiched between the electrically insulative flexible base material and the copper layer.

By means of the application of the plasma polymerization technology, the layer of plasma polymer having a cross-linked and branched structure is formed on the surface of the electrically insulative base material. The layer of plasma polymer has excellent mechanical properties and high thermostability. Therefore, the layer of plasma polymer greatly increases the bond strength between the electrically insulative base material and the copper layer without reducing the flexibility of the electrically insulative base material, and is practical for the application of the next generation of packaging technology.

### BRIEF DESCRIPTION OF THE DRAWINGS

FIG. 1 is a system block diagram of a plasma polymerization system according to the present invention.

FIG. 2 is a schematic view showing the structure of an adhesiveless flexible substrate according to the present invention.

### DETAILED DESCRIPTION OF THE INVENTION

The method of manufacturing an adhesiveless flexible substrate according to the present invention comprises the steps as follows.
A. Prepare an electrically insulative base material.
B. Plate a layer of plasma polymer on a surface of the electrically insulative base material by way of a plasma polymerization process under the presence of a polymerization gas and the application of an electric power.
C. Plate a copper layer on a surface of the layer of plasma polymer.

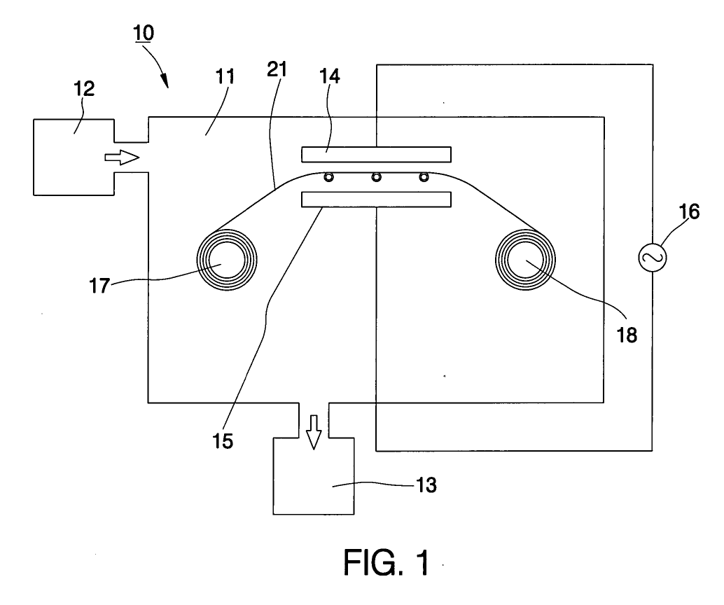

Referring to FIG. 1, a plasma polymerization system 10 is shown for making the adhesiveless flexible substrates according to the present invention. The plasma polymerization system 10 comprises a chamber 11, a gas supplier 12 for supplying the polymerization gas to the chamber 11, a vacuum pump 13 for pumping the gas out of the chamber 11, two electrodes 14 and 15 mounted inside the chamber 11 and electrically connected to a power supply 16, a material supply roll 17 for supplying a continuous sheet of the insulative flexible base material 21 passing through between the electrodes 14 and 15, and a material roll-up roll 18 for rolling up the continuous sheet of the flexible insulative base material 21.

The polymerization gas used in the plasma polymerization process is selected from argon (Ar), oxygen (O₂), carbon monoxide (CO), carbon dioxide (CO₂), nitrogen (N₂), nitrogen monoxide (NO), nitrogen dioxide (NO₂), ammonia (NH₃), hydrogen (H₂), hydrocarbon, silicone compound, air, or their combination. The flexible insulative base material 21 is selected from polyimide, polyester, polyethylene terephthalate, epoxy resin, or acrylate resin.

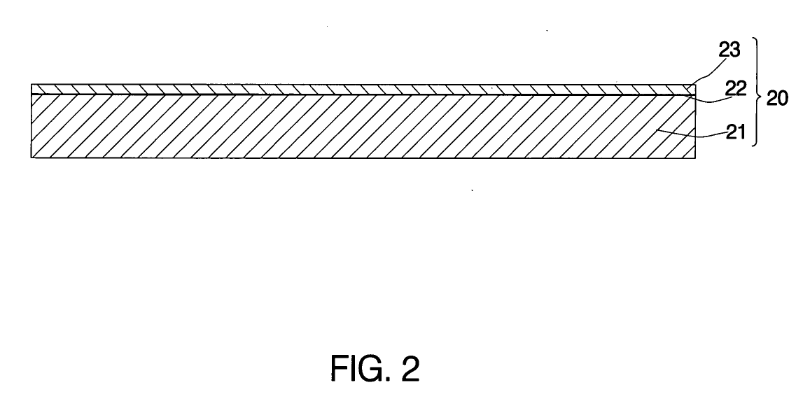

Electric field produced between the electrodes 14 and 15 dissociates intake polymerization gas into the status of plasma, enabling the plasma thus produced to be attached to the surface of the flexible insulative base material 21. As shown in FIG. 2, a thin layer of plasma polymer 22 is deposited on the surface of the flexible insulative base material 21 and used as a modified surface for the flexible insulative base material 21, and then a copper layer 23 having a thickness within a range of 1-72 μm is coated on the surface of the thin layer of plasma polymer 22 by a dry plating process, such as spatter-plating, evaporation plating, and ion plating, or by a wet plating process, such as non-electrolysis plating and electrolysis plating.

Because the thin layer of plasma polymer 22 has a cross-linked and branched structure, it has excellent mechanical properties that greatly improve the bond strength between the flexible insulative base material 21 and the copper layer 23 without reducing the flexibility of the flexible insulative base material 21. Therefore, an adhesiveless flexible substrate 20 made according to the present invention is flexible and highly reliable.

According to a first preferred embodiment of the present invention, the flexible insulative base material is made of Kapton E(N), and the polymerization gas is used to modify the surface of the flexible insulative base material by means of glow discharge of radio frequency at plasma parameters of power: 200 W, gas flow rate: 20 sccm, and working time: one minute. Thereafter, the copper layer is coated on the modified surface. Strength test shows that the bond strength of the adhesiveless flexible substrate is increased from 0.012 kg/cm before modification to 1.1 kg/cm after modification, i.e., increased by 91.67 times.

According to a second preferred embodiment of the present invention, the flexible insulative base material is made of Upilex S, and the polymerization gas is used to modify the surface of the flexible insulative base material by means of the glow discharge of the radio frequency at plasma parameters of power: 200 W, gas flow rate: 20 sccm, and working time: one minute. Thereafter, a copper layer was coated on the modified surface. Strength test shows that the bond strength is increased from 0.007 kg/cm before modification to 0.97 kg/cm after modification, i.e., increased by 138.57 times.

Therefore, the invention uses plasma polymerization technology to modify the surface of the flexible insulative base material, and the layer of plasma polymer thus polymerized shows enhanced bond strength between the flexible insulative base material and the copper layer when examined, thereby improving the reliability of the adhesiveless flexible substrate for a long use. Because the layer of plasma polymer has excellent mechanical properties, the flexibility of the flexible insulative base material will not be reduced. Therefore, the invention can be employed to manufacture the highly flexible insulative boards to fit the new generation of packaging technology, so as to further manufacture products of high quality, high reliability, and low cost.

It is to be understood that the aforementioned plasma can be also produced by arc discharge or corona discharge in addition to the glow discharge. As regards range of the aforementioned parameters, the plasma power is within a range of 1-1000 W, the gas flow rate is within a range of 1-1000 sccm, and the working time is within a range from one second to 30 minutes.

1. A method of manufacturing an adhesiveless flexible substrate comprising steps of:
(a) preparing an electrically insulative base material;
(b) plating a layer of plasma polymer on a surface of said electrically insulative base material by way of a plasma polymerization process under a polymerization gas and an electric power; and
(c) plating a copper layer on a surface of said layer of plasma polymer.

2. The method as defined in claim 1, wherein said electrically insulative base material is made of an insulative material selected from the group consisting of polyimide, polyester, polyethylene terephthalate, epoxy resin, and acrylate resin.

3. The method as defined in claim 1, wherein said polymerization gas is selected from the group consisting of argon, oxygen, carbon monoxide, carbon dioxide, nitrogen, nitrogen monoxide, nitrogen dioxide, ammonia, hydrogen, hydrocarbon, silicone compound, air, and combination thereof.

4. The method as defined in claim 1, wherein said plasma polymer is produced by glow discharge, arc discharge, or corona discharge.

5. The method as defined in claim 1, wherein said copper layer is plated on the surface of said layer of plasma polymer by means of a dry plating process, said dry plating process being spatter-plating, evaporation plating, or ion plating.

6. The method as defined in claim 1, wherein said copper layer is plated on the surface of said layer of plasma polymer by means of wet plating process, said wet plating process being non-electrolysis plating or electrolysis plating.

7. The method as defined in claim 1, wherein said copper layer comprises a thickness within a range of 1-72 μm.

8. The method as defined in claim 1, wherein said electric power in said plasma polymerization process is within a range of 1-1000 W.

9. The method as defined in claim 1, wherein said polymerization gas is supplied at a flow rate of within a range of 1-1000 sccm.

10. The method as defined in claim 1, wherein said polymerization process takes a period of time within a range from one second to 30 minutes.

11. An adhesiveless flexible substrate comprising an electrically insulative flexible base material, a copper layer, and a layer of plasma polymer sandwiched between said electrically insulative flexible base material and said copper layer.

12. The adhesiveless flexible substrate as defined in claim 11, wherein said electrically insulative flexible base material is made of an insulative material selected from the group consisting of polyimide, polyester, polyethylene terephthalate, epoxy resin, and acrylate resin.
